(19) United States
(12) Patent Application Publication
(10) Pub. No.: US 2010/0109973 A1
(43) Pub. Date: May 6, 2010

(54) METHOD AND APPARATUS FOR DETERMINING PRIORITY

(75) Inventor: Sung-wook Byun, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/509,706

(22) Filed: Jul. 27, 2009

(30) Foreign Application Priority Data
Nov. 6, 2008 (KR) 10-2008-0110003

(51) Int. Cl. G09G 5/00

(52) U.S. Cl. 345/2.1

(57) ABSTRACT

A method of determining priority among a plurality of remote display devices is provided, the method including: detecting a remote display device, among the plurality of remote display devices, that is within a predetermined recognition range; assigning a priority to the detected remote display device; and allocating a predetermined function to the detected remote display device according to the assigned priority.

### CROSS-REFERENCE TO RELATED PATENT APPLICATIONS

This application claims the priority from Korean Patent Application No. 10-2008-0110003, filed Nov. 6, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relates to determining priority among a plurality of remote display devices that perform predetermined functions in conjunction with an image processing apparatus.

2. Description of the Related Art

Recently, terminals that control functions of a television (TV) or a peripheral device of the TV and provide various services via a wireless network are widely used. The main functions of the terminals are to remotely control an audio/video (A/V) home appliance, such as a TV or set-top box, to receive an image signal from the A/V home appliance, and to view a TV program.

### SUMMARY OF THE INVENTION

The present invention provides a method and an apparatus for determining priority of a plurality of remote display devices and a computer readable recording medium having recorded thereon a program for executing the method.

According to an aspect of the present invention, there is provided a method of determining priority among a plurality of remote display devices, the method including: detecting a remote display device, among the plurality of remote display devices, that is within a predetermined recognition range; assigning priority to the detected remote display device; and allocating a predetermined function to the detected remote display device according to the priority.

The assigning priority to the detected remote display device may include, when a power-on signal is received from the remote display device, giving highest priority to the remote display device transmitting the power-on signal.

The allocating a predetermined function may include allocating a function by which all services of the remote display device are used to the remote display device having the highest priority.

The method may further include selectively allocating a function by which predetermined services of services excluding the service used only by the remote display device having the highest priority is provided to other remote display devices having lower priorities.

The method may further include giving priority to the other remote display devices having lower priorities according to a sequence in which the other remote display devices are detected.

The method may further include: receiving a priority request signal with respect to high priority from at least one remote display device having lower priority; and transmitting the priority request signal to the remote display device having higher priority.

The method may further include: receiving an approval signal with respect to the priority request signal from the remote display device having the higher priority; and allocating a function of the remote display device having the higher priority to the remote display device which transmits the priority request signal.

According to another aspect of the present invention, there is provided a computer readable recording medium having embodied thereon a computer program for executing the method of determining priority among a plurality of remote display devices, the method including: detecting a remote display device, among the plurality of remote display devices, that is within a predetermined recognition range; assigning priority to the detected remote display device; and allocating a predetermined function to the detected remote display device according to the priority.

According to another aspect of the present invention, there is provided an image processing apparatus that communicates with a plurality of remote display devices, the apparatus including: a detection unit that detects a remote display device that is within a predetermined recognition range from among the plurality of remote display devices; and a control unit that assigns priority to the detected remote display device and adjusts a predetermined function to be allocated to the detected remote display device according to the priority.

### BRIEF DESCRIPTION OF THE DRAWINGS

The above and/or other aspects of the present invention will become more apparent by describing certain exemplary embodiments thereof with reference to the accompanying drawings, in which:

FIG. 1 is a block diagram of an image processing apparatus and a plurality of remote display devices according to an exemplary embodiment of the present invention;

FIG. 2 is a more detailed diagram of the remote display devices illustrated in FIG. 1;

FIG. 3 is a flowchart illustrating a method of determining priority among a plurality of remote display devices, according to an exemplary embodiment of the present invention; and

FIG. 4 is a flowchart illustrating an operation of allocating a function of a remote display device having a higher priority to a remote display device having a lower priority, according to an exemplary embodiment of the present invention.

### DETAILED DESCRIPTION OF EXEMPLARY EMBODIMENTS

Exemplary embodiments of the present invention are described in greater detail below with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

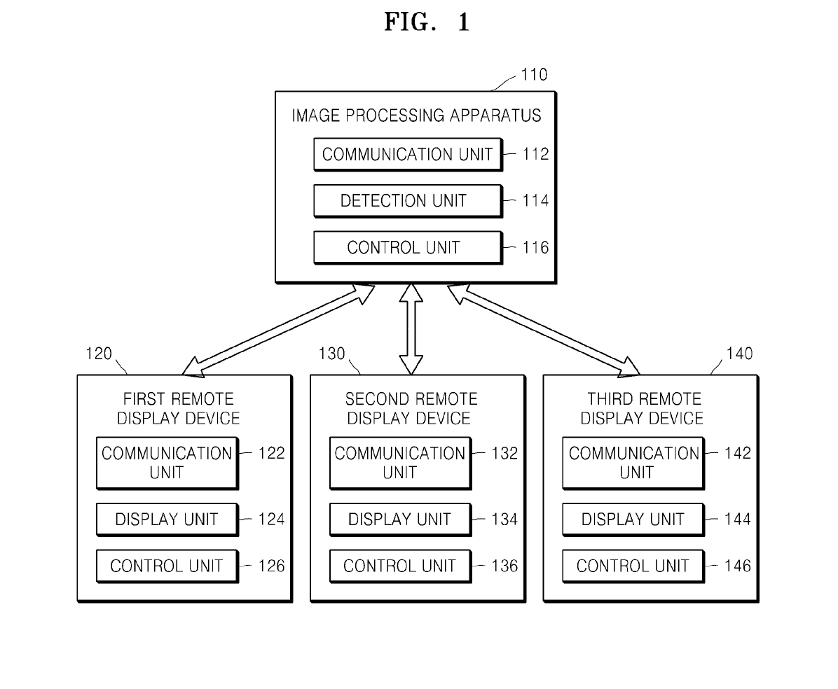

FIG. 1 is a block diagram of an image processing apparatus 110 and a plurality of remote devices, i.e., first, second and third remote display devices 120, 130, and 140, according to an exemplary embodiment of the present invention. Although three (first through third) remote display devices are shown in FIG. 1 by way of example, the number of remote display devices is not limited thereto. Referring to FIG. 1, the image processing apparatus 110 according to the current exemplary embodiment includes a communication unit 112, a detection unit 114, and a control unit 116. The first, second and third remote display devices 120, 130, and 140 according to the current exemplary embodiment respectively include a communication units unit 122, 132, and 142, a display units 124, 134, and 144, and a control units 126, 136, and 146.

The first, second and third remote display devices 120, 130, and 140 may receive image signals and various information from the image processing apparatus 110 or the Internet and provide services that may be used by users, e.g., an electronic program guide (EPG), watching TV programs, Internet browsing, reproducing A/V contents, widgets, external input reproduction, games, etc.

The image processing apparatus 110 may be a TV or a peripheral device that communicates with a TV in a wired or wireless manner. For example, the image processing apparatus 110 may be a set-top box. A set-top box amplifies an image signal received from an antenna or a cable, and/or eliminates noise generated in the antenna or cable to transmit the image signal to the TV. A set-top box and a TV may be connected as a pair.

The communication unit 112 may transmit or receive an image signal or other control signals to or from at least one of the first, second and third remote display devices 120, 130, and 140. In the current exemplary embodiment of the present invention, the communication unit 112 may communicate with the first, second and third remote display devices 120, 130, and 140 via a wireless network, but the present invention is not limited to the current exemplary embodiment.

The detection unit 114 detects the first, second and third remote display devices 120, 130, and 140 if the first, second and third display devices 120, 130, and 140 are within a predetermined recognition range when the image processing apparatus 100 is turned on. The detection unit 114 may detect any of the first, second and third remote display devices 120, 130, and 140 when they are turned on. In addition, the detection unit 114 may detect the first, second and third remote display devices 120, 130, and 140 periodically after the image processing apparatus 110 is turned on.

When the first, second and third remote display devices 120, 130, and 140 are detected, the control unit 116 assigns a priority to the first, second, and third display devices 120, 130, and 140. Priority refers to the priority to be given according to remote control or other service performed by the first, second and third remote display devices 120, 130, and 140 in combination with the image processing apparatus 110. If any one of the first, second and third remote display devices 120, 130, and 140 detected has a high priority, numerous services made available to such device, and if any one thereof has a low priority, available services are made limited. Accordingly, the control unit 116 of the image processing apparatus 110 adjusts functions of the first, second and third remote display devices 120, 130, and 140 according to the priority thereof.

For example, the highest priority is given to one of the first, second and third remote display devices 120, 130, and 140 which outputs a remote control signal used to turn on the image processing apparatus 110. The highest priority is given access to all functions including a remote control function or services of the image processing apparatus 110. The control unit 116 allocates functions of available services exclusive of the services used only by one of the first, second and third remote display devices 120, 130, and 140 having the highest priority, to the remaining two of the first, second and third remote display devices 120, 130, and 140 having the lower priority. In the current exemplary embodiment, in order to prevent conflict of control of the image processing apparatus 110 among the first, second and third remote display devices 120, 130, and 140, a remote control function is allocated to only one the first, second and third remote display devices 120, 130, and 140. More specifically, a remote control function may be allocated to one of the first, second and third remote display devices 120, 130, and 140, to which the highest priority is given. Distributing of functions according to the priority may be set by a user of the image processing apparatus 110 or one of the first, second and third remote display devices 120, 130, and 140.

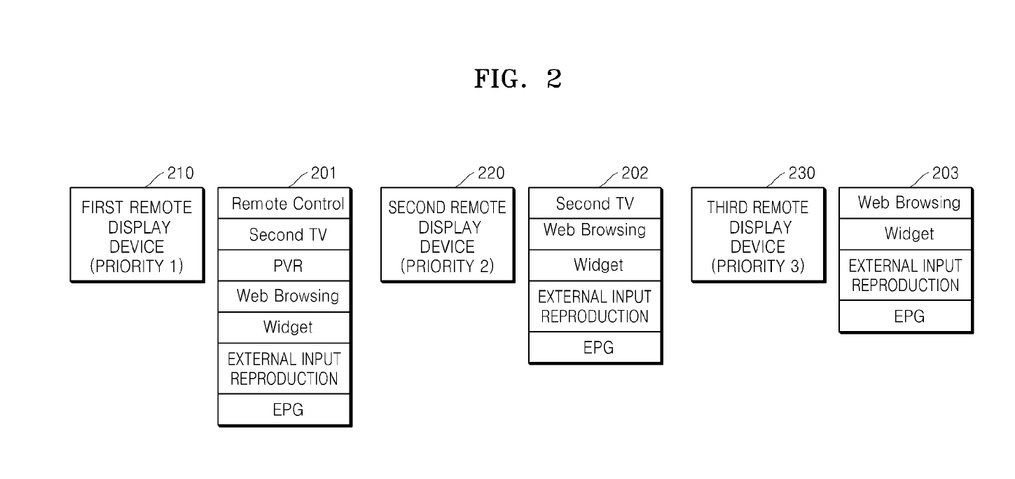

FIG. 2 is a diagram for explaining functions of the remote display devices illustrated in FIG. 1, according to the priority. Referring to FIG. 2, a first remote display device 210 is given the highest priority or a first priority. A second remote display device 220 is given the next highest priority or a second priority. A third remote display device 230 is given the lowest priority or a third priority. Blocks corresponding to reference numerals 201, 202, and 203 denote functions that may be performed by the first, second, and third remote display devices 210, 220, and 230, respectively.

The first remote display device 210, having the highest priority, may use any of the functions of the first, second, and third remote display devices 210, 220, and 230 in combination with the image processing apparatus 110. Referring to FIG. 2, a remote control function 240 controls the image processing apparatus 110 from a remote place. An electronic program guide (EPG) 242 displays a table of TV broadcasting programs or detailed information about the table on a screen. A web browsing function 244 browses the Internet. A widget function 246 allows a user to interact with a graphic user interface element. A second TV function 250 views a TV broadcasting of a channel other than that of a channel displayed on the image processing apparatus 110 by using a remote display device. An external input reproduction function 252 reproduces an output of an external device input to the image processing apparatus 110. A personal video recorder (PVR) function 254 allows a digital recording device to reproduce information recorded on a hard disk. The first remote display device 210, having the highest priority, may use all of the functions listed. Functions, exclusive of the services used only by the first remote display device 210 having the highest priority, are allocated to the second and third remote display devices 220 and 230 having the lower priority.

In FIG. 2, the second remote display device 220 may use the second TV function 250, the web browsing function 244, the widget function 246, the external input reproduction function 252, and the EPG function 242. The third remote display device 230, having the lowest priority, may use the web browsing function 244, the widget function 246, the external input reproduction function 252, and the EPG function 242. However, the present invention is not limited to the current exemplary embodiment.

Generally, the second TV and the PVR functions 250, 254 may be used by a plurality of users only when supported by hardware having specialized services. In addition, services that can be used simultaneously by a plurality of users may be the external input reproduction function 252, the web browsing function 242, the widget function 246, and the EPG function 242. The external input reproduction, the web browser, the widget, and the EPG functions may be allocated to the second remote display device 220 or the third remote display device 230.

According to an exemplary embodiment of the present invention, when a priority request signal requesting a higher priority is received from a remote display device having a lower priority, for example, the third remote display device 230, the control unit 116 transmits the priority request signal to the remote display devices having a higher priority than the third remote display device 230, for example, the first remote display device 210 or the second remote display device 220. In this case, a user of the remote display device having the higher priority may approve the request. When receiving an approval signal with respect to the priority request signal from the remote display device having the higher priority, the control unit 116 may allocate functions of the remote display devices having the higher priority to the remote display device which transmits the priority request signal.

The first, second and third remote display devices 120, 130, and 140 refer to terminals that control the function of the image processing apparatus 110, such as, a digital TV, and are provided with various services via a wireless network. The first, second and third remote display devices 120, 130, and 140 may perform functions such as the remote control, the EPG, the web browsing, the widget, the second TV, the external input reproduction, and the PVR functions. In particular, the first, second and third remote display devices 120, 130, and 140 include display units 124, 134, and 144, respectively. Thus, the first, second and third remote display devices 120, 130, and 140 may receive an image signal from the image processing device 110, a peripheral device of the image processing device 110, or via the Internet, and may view an image corresponding to the image signal received by using the first, second and third remote display devices 120, 130, and 140. The communication units 122, 132, and 142 transmit and receive each signal to and from the image processing device 110 via the Internet. The control units 126, 136 and 146 control all functions of the first, second, and third remote display devices 120, 130, and 140. The first, second and third remote display devices 120, 130, and 140 may be used in a mobile device that controls a device for reproducing images and the image processing apparatus 110.

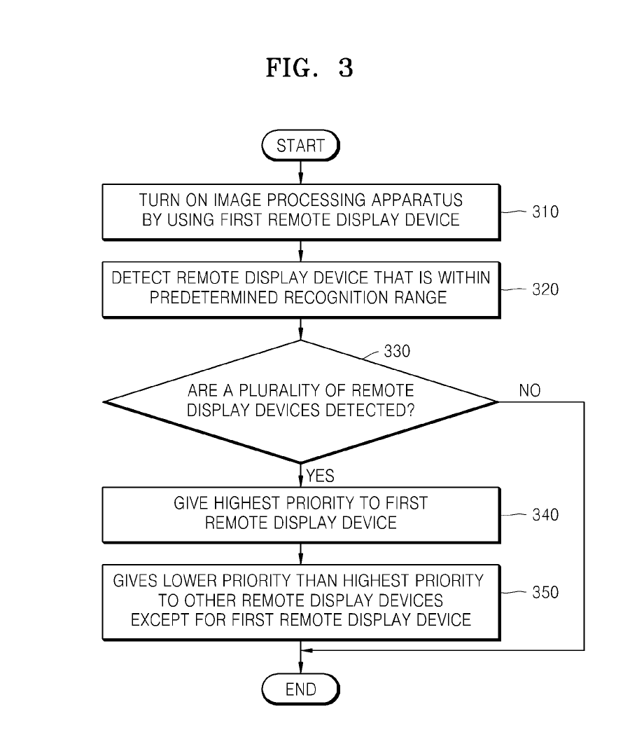

FIG. 3 is a flowchart illustrating a method of determining the priority among a plurality of remote display devices, according to an exemplary embodiment of the present invention. Referring to FIG. 3, in operation 310, the image processing apparatus 110 is turned on by using the first remote display device 120. In operation 320, the image processing apparatus 110 detects at least one of the first, second and third remote display devices 120, 130, and 140, if the first, second and third remote display devices 120, 130, and 140 is within a predetermined recognition range.

When the first, second and third remote display devices 120, 130, and 140 are detected in operation 330, priority is given to each of the first, second and third remote display devices 120, 130, and 140. Priority refers to a priority to be given according to remote control or services performed by the first, second and third remote display devices 120, 130, and 140 in combination with the image processing apparatus 110. If any one of the detected first, second and third remote display devices 120, 130, and 140 has a high priority, more diverse services are made available. If the detected first, second, and third remote display device 120, 130, and 140 has a low priority, limited services are made available. In operation 340, the image processing apparatus 110 gives the highest priority to the first remote display device 120 which transmits a power-on signal. In this case, the image processing apparatus 110 allocates a predetermined function, according to the highest priority to the first remote display device 120. The image processing apparatus 110 allocates a function by which all services, including remote control of the image processing apparatus 110, may be used by the first remote display device, having the highest priority.

Subsequently, in operation 350, the image processing apparatus 110 assigns lower priority levels to the second and third remote display devices 130 and 140. In this case, the image processing apparatus 110 allocates available services by using the remaining resources, exclusive of the services used only by the first remote display device 120 having the highest priority. A function that is not used only by the first remote display device 120 having the highest priority may be allocated to the second and third remote display devices 130 and 140 having the lower priority. In an exemplary embodiment of the present invention, in order to prevent conflict of remote control function of the image processing apparatus 110 due to the existence of the plurality of first, second and third remote display devices 120, 130, and 140, a remote control function may be allocated to only one of the first, second and third remote display devices 120, 130, and 140. Distribution of functions according to the priority may be set by a user of the image processing apparatus 110 or one of the first, second and third remote display devices 120, 130, and 140.

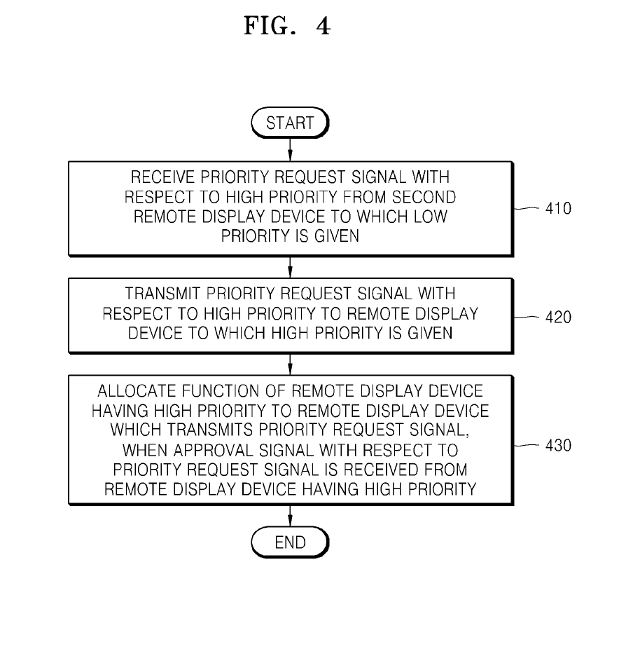

FIG. 4 is a flowchart illustrating an operation of allocating a function of remote display devices having a higher priority to a remote display device having a lower priority, according to an exemplary embodiment of the present invention. Referring to FIG. 4, in operation 410, a higher priority request signal to request the higher priority is transmitted by the remote display device having the lower priority. For example, the second remote display device 130 requests a higher priority. In operation 420, the higher priority request signal is transmitted to a remote display device having the assigned higher priority. For example, the first remote display device 120 has the assigned higher priority. In this case, a user of the first remote display device 120 having the higher priority may approve the request. In operation 430, an approval signal with respect to the higher priority request signal is received by the second remote display device 130 having the lower priority. A function of the remote display device having the higher priority is allocated to the second remote display device 130.

In addition, exemplary embodiments may be implemented through computer readable code/instructions recorded in/on a recording medium, e.g., a computer-readable medium, to control at least one processing element to implement any exemplary embodiment. The recording medium may correspond to any medium/media permitting the storage and/or transmission of the computer readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs). Thus, the medium may be such a defined and measurable structure including or carrying information, such as a device carrying a bitstream according to one or more exemplary embodiments.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of determining priority among a plurality of remote display devices, the method comprising:
detecting a remote display device, among the plurality of remote display devices, that is within a predetermined recognition range;
assigning priority to the detected remote display device; and
allocating a predetermined function to the detected remote display device according to the assigned priority.

2. The method of claim 1, wherein the assigning priority to the detected remote display device comprises, when a power-on signal is received from the remote display device, assigning highest priority to the remote display device transmitting the power-on signal.

3. The method of claim 2, wherein the allocating the predetermined function comprises:
allocating a primary function by which all services available to the remote display device are allocated to the remote display device having the assigned highest priority.

4. The method of claim 3, further comprising:
detecting other remote display devices disposed within the predetermined recognition range;
assigning lower priorities to the detected other remote display devices; and
selectively allocating secondary functions, by which predetermined available services exclusive of the services used only by the remote display device having the highest priority are allocated to the other remote display devices having the assigned lower priorities.

5. The method of claim 4, wherein the assigning the lower priorities comprises assigning the lower priorities to the other detected remote display devices according to a sequence in which the other remote display devices are detected.

6. The method of claim 4, further comprising:
receiving a priority request signal with requesting to grant a higher priority from a requesting remote display device having the lower priority; and
transmitting the priority request signal to the remote display device having a higher priority assigned than the requesting remote display device.

7. The method of claim 6, further comprising:
receiving an approval signal requesting permission to grant the requested higher priority from the remote display device having the higher priority assigned; and
allocating a respective function of one of the remote display devices having the higher priority to the requesting remote display device.

8. A computer-readable recording medium having embodied thereon a computer program, which computer program, when executed by a computer, causes the computer to execute a method of determining priority among a plurality of remote display devices, the method comprising:
detecting a remote display device, among the plurality of remote display devices, that is within a predetermined recognition range;
assigning the priority to the detected remote display device; and
allocating a predetermined function to the detected remote display device according to the assigned priority.

9. An image processing apparatus that communicates with a plurality of remote display devices, the apparatus comprising:
a detection unit which detects a remote display device, among the plurality of remote display devices, that is within a predetermined recognition range; and
a control unit which assigns priority to the detected remote display device and allocates a predetermined function to the detected remote display device according to the assigned priority.

10. The apparatus of claim 9, wherein the control unit assigns highest priority to the remote display device if the image processing apparatus is turned on by the remote display device.

11. The apparatus of claim 10, wherein the control unit allocates a function by which all available services of the remote display device are allocated for use to the remote display device having the highest priority.

12. The apparatus of claim 11, wherein the detection unit detects other remote display devices disposed within the predetermined recognition range, to which the control unit assigns lower priorities, and selectively allocates functions by which predetermined available services exclusive of the services allocated for use by only the remote display device having the highest priority are allocated to the other remote display devices.

13. The apparatus of claim 12, wherein the control unit assigns the lower priorities to the other remote display devices according to a sequence in which the other remote display devices are detected.

14. The apparatus of claim 12, wherein, when receiving a priority request signal requesting to grant a higher priority from a requesting remote display device having the lower priority, the control unit transmits the priority request signal to the remote display device having a higher priority than the requesting remote display device.

15. The apparatus of claim 14, wherein, when receiving an approval signal requesting permission to grant the higher priority to the requesting remote display device, the control unit allocates a function of one of the remote display devices having the higher priority to the requesting remote display device.
